(19) United States
(12) Patent Application Publication
(10) Pub. No.: US 2008/0006732 A1
(43) Pub. Date: Jan. 10, 2008

(54) Differential dual spool retractor seat belt system with motor actuator

(75) Inventors: Gunter K. Clute, Bloomfield Hills, MI (US); Jennifer Grove, White Lake, MI (US)

Correspondence Address: AUTOLIV ASP, 3350 AIRORT ROAD, OGDEN, UT, 84405, US

(73) Assignee: Autoliv ASP, Inc.

(21) Appl. No.: 11/483,904

(22) Filed: Jul. 10, 2006

(51) Int. Cl. B60R 22/34

(52) U.S. Cl. 242/390.5; 242/374; 242/390.8

(57) ABSTRACT

A dual spool retractor device for seat belts in a motor vehicle including a frame, a motor, and two spools rotatably mounted to the frame. The spools are each attached to one end of a seat belt and configured to retract the belt upon rotation. The motor is mechanically coupled to both of the spools via a differential drive arrangement configured to impart rotation to both of the spools, while allowing the spools to rotate independently if one spool is stalled. The differential drive arrangement may include a differential gear set.

### BACKGROUND OF THE INVENTION

1. Field of the Invention

The present invention generally relates to automotive safety restraint systems for motor vehicles. More specifically, the invention relates to an active three-point seat belt system having dual seat belt retractor spools mounted to a common frame.

2. Description of Related Art

Motor vehicle seat belt restraint systems are available in a number of configurations. The most common in modern automobiles makes use of a shoulder belt and a lap belt. This configuration uses either a single continuous length of belt webbing, provided with a single retractor, or dual independent belts each having their own retractor.

In the single belt arrangement a latch plate slides along the belt. One end of the belt is attached to a first anchor point secured to the vehicle on one side of the seat. The other end is attached to a rotatable spool retractor secured to the vehicle at a second anchor point which can be on the floor pan, side pillar, or seat structure. To secure an occupant, the latch plate is inserted into a buckle, located opposite the anchor, and the belt slides through the latch plate as the spool draws in or pays out the safety belt.

The dual independent belt arrangement has two belts each individually attached to the latch plate at one end and secured to a separate rotatable retractor spool at the other. In most vehicles with dual retractors, each retractor spool is remotely mounted, independent of the other spool. To secure an occupant, the latch plate is inserted into the buckle. Each retractor spool separately pays out or draws in the lap and shoulder belt webbing as necessary. This configuration is more costly due to the provision of an additional retractor. In addition, assembly and mounting within the vehicle is more complex because each retractor spool may be independently mounted to the vehicle. However, it is desirable in premium vehicles due to the additional comfort and convenience the system provides for the occupants.

A further complication of the second retractor of a dual belt system arises with the inclusion of a pre-tensioning system. Pre-tensioning systems may be activated by a control system that, for example, senses emergency braking or, similar to an airbag, detects an actual or impending vehicle collision. If the system detects an appropriate event, the pre-tensioning system causes the spools to quickly draw-in slack from the safety belts, thereby enabling the restraint system to engage the occupant early in the collision sequence.

In a single belt system, the pre-tensioning device need only be coupled to a single retractor spool. However, in a dual belt system, if pre-tensioning is desired on both spools, the system must have devices coupled to both spools. This is a more complex and costly configuration since the control system must be configured to actuate both devices. In addition, if one spool draws in all the slack from one belt and stops rotating, the control system must continue to drive the other pre-tensioning device to draw in the slack remaining in the other belt.

Various designs of pre-tensioners are known. One type, known as a roto-pretensioner, incorporates a series of balls in a gas duct which are driven by the deployment of a micro gas generator to engage with and wind a spool to retract the belt. In a dual belt system two such roto-pretensioners may be required.

Alternatively, an electric motor pre-tensioner may be provided. These pre-tensioners use electric motors to drive the spools, and have added flexibility since the control system may be configured to retract slack in non-emergency situations. For example, the system may be configured to retract the slack in the belts when an occupant exits the vehicle. However, existing electric motor driven retractors require an independent electrical motor for each retractor spool. This results in additional cost and complexity.

In view of the above, it is apparent that there exists a need for a differential dual spool retractor seat belt device with the flexibility of electric motor drive with reduced complexity.

### BRIEF SUMMARY OF THE INVENTION

In satisfying the above need, as well as overcoming the enumerated drawbacks and other limitations of the related art, the present invention provides a dual spool retractor device for seat belts in a motor vehicle comprising a frame, a motor mounted thereto, and two retractor spools rotatably mounted to the frame. The spools are each attached to one end of a seat belt, and the motor is mechanically coupled to both of the spools via a drive arrangement having a differential gear set. Activation of the motor imparts rotation to the spools, causing the seat belts to draw onto the spools. The drive arrangement in accordance with this invention enables a single motor to drive both spools while allowing the spools to retract webbing independent of one another.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a perspective view of a dual spool retractor system in accordance with a first embodiment of this invention installed inside a motor vehicle including a vehicle seat.

FIG. 2 is a front view of the dual spool retractor device shown in FIG. 1.

FIG. 3 is a side view of the dual spool retractor device shown in FIG. 1.

FIG. 4 is a cross-sectional view of a differential gear set of the retractor shown in FIGS. 1 through 3.

FIG. 5 is a front view of an alternate dual spool retractor device.

FIG. 6 is a side view of the alternate dual spool retractor device.

### DETAILED DESCRIPTION

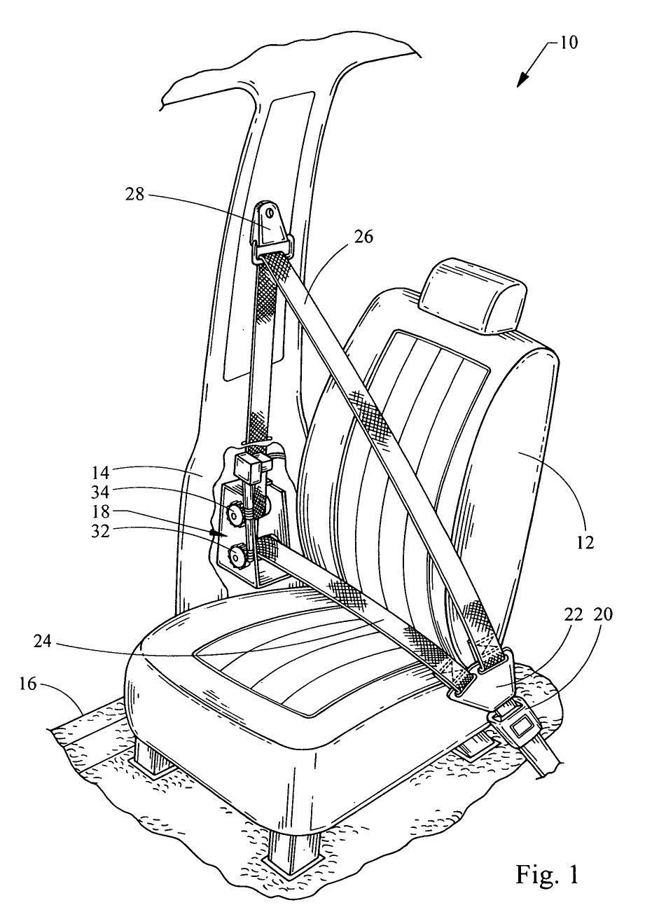

Referring now to the drawings, a restraint system embodying the principles of the present invention is illustrated in FIG. 1 and designated at 10. As its primary components, the system 10 includes a vehicle seat 12 and a dual spool retractor 18, both mounted to the vehicle body structure 16. Located relative to the seat 12 is a buckle 20, also secured to the body structure 16, into which a latch plate 22 is inserted and removably secured. Extending between the retractor 18 and affixed to the latch plate 22 are a lap belt 24 and a shoulder belt 26 wherein the retractor 18 is configured to control the belts 24 and 26.

Looking more closely at the belts 24 and 26 shown in FIG. 1, the latch plate 22 is affixed to one end each of the lap belt 24 and the shoulder belt 26. When the latch plate 22 is released from the buckle 20, the retractor 18 of the present embodiment may retract each of the belts 24 and 26 until the latch plate 22 parks to any desired position.

A guide loop 28 is usually fixed to a vehicle side pillar 14 (or to the seat 12) in a stationary manner at approximately shoulder height of an occupant (not shown). In some embodiments, the position of the guide loop 28 may be vertically adjustable. The purpose of the guide loop 28 is to position the shoulder belt 26 across a shoulder and chest of the passenger and to re-direct it back into the retractor 18. Alternatively, some configurations of the retractor 18 may have sufficient height to comfortably position the shoulder belt 26 without the guide loop 28. In either case, the guide loop 28 may be adjustable to allow occupants to fine-tune the position of the shoulder belt 26.

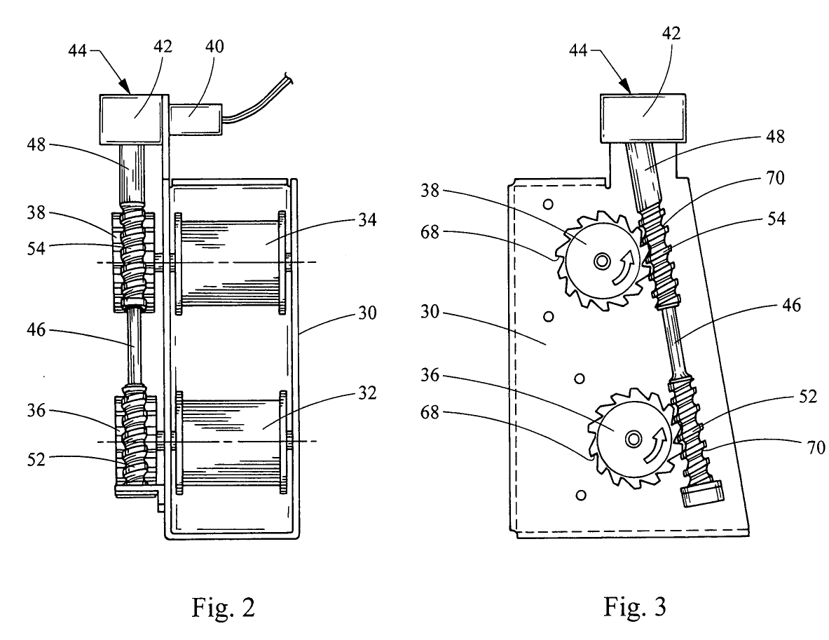

Turning now to FIGS. 2 and 3 the dual spool retractor 18 according to the present invention is shown and includes a frame 30 into which both the lap belt spool 32, and a shoulder belt spool 34 are rotatably mounted. Mechanically coupled to each respective spool 32 and 34 are a lap worm wheel 36 and a shoulder worm wheel 38 whereby rotation of the worm wheels 36 and 38 cause the respective spools 32 and 34 to rotate.

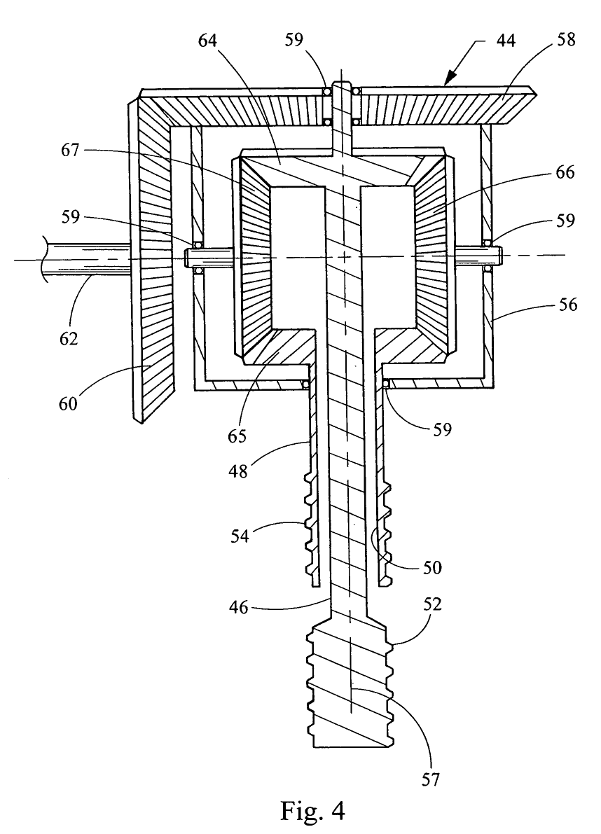

A motor 40, coupled to a differential drive arrangement 42, is also affixed to the frame 30. The motor 40 may be any conventional device capable of rotating a shaft including, but not limited to, electrical, hydraulic, pneumatic or torsion spring devices. The differential drive arrangement 42, according to a preferred embodiment of the present invention, includes a differential gear set 44 (shown in FIG. 4). However, it should be appreciated that the differential gear set 44 is but one example of a differential drive arrangement 42. Other examples may include hydraulic or fluid couplers or any other means of imparting torque to two spools while also permitting independent rotation.

Referring back to FIG. 2, a first drive shaft 46, and a second drive shaft 48 extend from the differential drive arrangement 42 and are rotatably coupled to the differential gear set 44 (shown in FIG. 4) of the differential drive arrangement 42. As best shown in FIG. 4, the shafts 46 and 48 are concentrically arranged about a central axis 57 such that the second shaft 48 rotates within a central bore 50 of the first shaft 46 or vice versa, allowing them to rotate independent of one another. The end of the first shaft 46 forms a first worm gear 52 and the end of the second shaft 48 forms a second worm gear 54. As best shown in FIG. 3, the worm gears 52 and 54 mesh with the worm wheels 36 and 38 respectively. Thus, when the motor 40 is activated, torque is imparted to both shafts 46 and 48 through the differential gear set 44, and the worm gears 52 and 54 transfer the rotation to the worm wheels 36 and 38 which in turn rotate the lap and shoulder spools 32 and 34. Since the lap and shoulder belts 24 and 26 are coupled to their respective spools 32 and 34, any slack from the belts 24 and 26 is effectively removed.

In the embodiment shown, the differential gear set 44, worm gears 52 and 54 and the worm wheels 36 and 38 are all configured to rotate the spools with roughly equal rotational speeds and in the same rotational direction as shown by the arrows in FIG. 3. However, the spools 32 and 34 may also rotate with different rotational speeds or in different rotational directions. In the present embodiment, this may be accomplished by, for example, providing additional gears between the differential gear set 44 and the shafts 46 and 48, changing a diameter or number of teeth of the worm wheels 36 and 38, changing a helix angle or number of starts on the worm gears 52 and 54, or by any appropriate combination thereof. Other embodiments may require other changes to rotate the spools with different rotational speeds or in different rotational directions.

The differential gear set 44 of FIG. 4, is well known in mechanical drive systems. It is composed primarily of a carrier 56 rotatably driven by a ring gear 58. A drive-shaft pinion 60, mounted to a motor-shaft 62 of the motor 40, mechanically engages the ring gear 58 causing it to rotate, along with the carrier 56, about the central axis 57 which is generally perpendicular to the motor-shaft 62. Both the ring gear 58 and the drive-shaft pinion 60 are rotatably mounted to the differential housing 42 using a bearing arrangement (not shown). Upon activation, the motor 40 imparts rotation to the motor-shaft 62 and, via the drive-shaft pinion 60, to the ring gear 58 and carrier 56. Included on each respective drive shaft 46 and 48 is a first side gear 64, and a second side gear 65 arranged to mesh with a first differential pinion 66 and a second differential pinion 67. Rotation of carrier 56 causes differential pinions 66 and 67 to rotate about the central axis 57. Bearings 59 are included to support the shafts 46 and 48 and the differential pinions 66 and 67 within the carrier 56. This arrangement, divides torque from the motor 40 equally between each shaft 46 and 48, and allows them to rotate at different speeds. If the rotation of one drive shaft 46 or 48 is stalled (i.e. stopped), the other drive shaft 46 and 48 may continue to rotate. The amount of torque being applied to the stalled shaft 46 and/or 48 is equal to the torque being applied to the other shaft 46 or 48.

The advantages of using the differential gear set 44 in the retractor 18 become apparent when one belt 24 or 26 has less slack than the other belt 24 or 26. For example, if the lap belt 24 has less slack, it will tighten and prevent rotation of the lap belt spool 32. However, the shoulder belt 26 may still have slack remaining, necessitating continued rotation of the shoulder belt spool 34. Including the differential gear set 44 between the motor 40 and the shafts 46, 48 solves this problem by permitting differential rotation of the spools 32 and 34.

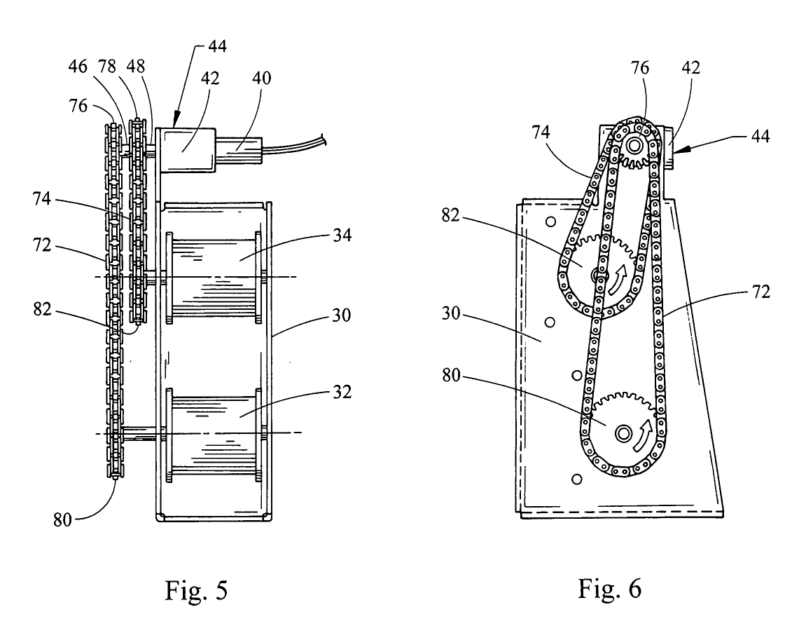

It is important to note that the above is an exemplary embodiment. As shown in FIGS. 5 and 6, another embodiment may include a first drive chain 72 and a second drive chain 74 (or drive belts, (not shown)) coupled to the differential gear set 44 of the differential drive arrangement 42. The chains 72 and 74 take the place of the drive shafts 46 and 48 shown in FIGS. 2 and 3. At one end the chains 72 and 74 are engaged with a first drive sprocket 76 and a second drive sprocket 78. At the other end the drive chains 72 and 74 are engaged with a first driven sprocket 80, coupled to the lap belt spool 32, and a second driven sprocket 82, coupled to the shoulder belt spool 34. If drive belts are used, the sprockets 76, 78, 80 and 82 may be replaced by appropriate pulley's.

The present invention reduces the cost and complexity of a dual spool pre-tensioning device by providing the same functionality as a dual motor device using a less costly single motor. First, like a dual motor device, the retractor device 18 may act as a belt pre-tensioner in response to a vehicle collision, and it may be used as a comfort and convenience device that retracts slack when, for example, the occupant exits the vehicle. Finally, if properly dimensioned, the use of worm gears 52 and 54 and worm wheels 36 and 38 by the present invention prevents the spools 32 and 34 from rotating when the motor 40 is not active, thereby preventing back driving of the spools 32 and 42. This is a consequence of the mesh between teeth 68 of the worm wheel and the helix angle of a helical surface 70 of the worm gear (see FIG. 3). Since the worm gear rotates about an axis transverse to the rotational axis of the worm wheel, the helical surface 70, with a sufficiently low helix angle, prevents the worm wheel from rotating unless the worm gear is rotating.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

We claim:

1. A dual spool retractor for lap and shoulder belts of a motor vehicle comprising:
a motor mounted to a frame,
two spools rotatably mounted to the frame, the spools each being attached to one of the lap and shoulder belts for retracting the belts upon rotation,
the motor being mechanically coupled to both of the spools by a differential drive arrangement configured to impart torque to both of the spools while allowing the spools to rotate independently.

2. The dual spool retractor device of claim 1 wherein the differential drive arrangement includes a differential gear set.

3. The dual spool retractor device of claim 1 further comprising at least two drive shafts each engaging one of the spools and the differential drive arrangement.

4. The dual spool retractor device of claim 3 wherein at least one drive shaft forms a central bore, the drive shafts being concentrically mounted one within the other along a common axis.

5. The dual spool retractor device of claim 3 wherein the drive shafts each form a worm gear and the spools each include a worm wheel, the worm gears being arranged to engage the worm wheels such that upon rotation of the worm gears the respective worm wheels and spools rotate.

6. The dual spool retractor device of claim 1 wherein the drive arrangement includes at least two drive belts coupled to each of the spools and further coupled to the differential drive arrangement.

7. The dual spool retractor device of claim 1 wherein the differential drive arrangement includes at least two drive chains coupled to each of the spools and further coupled to the differential drive arrangement.

8. The dual spool retractor device of claim 1 wherein the differential drive arrangement is configured to provide different rotational speeds to each of the spools.

9. The dual spool retractor device of claim 1 wherein the differential drive arrangement is configured to rotate each of the spools in different directions.

10. The dual spool retractor device of claim 1 wherein the motor is an electric motor.

11. The dual spool retractor device of claim 1 wherein the motor is a hydraulic motor.

12. The dual spool retractor device of claim 1 wherein the motor is a pneumatic motor.

13. The dual spool retractor device of claim 1 wherein the motor is a torsion spring device.

14. A dual spool retractor for lap and should belts in a motor vehicle comprising:
an electric motor mounted to a frame,
two spools rotatably mounted to the frame, the spools each being attached to one of the lap and shoulder belts for retracting the belts upon rotation,
the motor being mechanically coupled to both of the spools by a differential gear set configured to impart torque to both of the spools while allowing the spools to rotate independently, the differential gear set being coupled to the spools by two drive shafts.

15. The dual spool retractor device of claim 14 wherein at least one drive shaft forms a central bore, the drive shafts being concentrically mounted one within the other along a common rotational axis.

16. The dual spool retractor device of claim 14 wherein the drive shafts each form a worm gear and the spools each include a worm wheel, the worm gear being arranged to contact the worm wheel such that upon rotation of the worm gears the respective worm wheels and spools rotate.

17. The dual spool retractor device of claim 14 wherein the spools are coupled to the differential gear set such that different rotational speeds are imparted to each of the spools.

18. The dual spool retractor device of claim 14 wherein the spools are coupled to the differential gear set such that different rotational directions are imparted to each of the spools.
